(19) United States
(12) Patent Application Publication
(10) Pub. No.: US 2013/0055775 A1
(43) Pub. Date: Mar. 7, 2013

(54) LOCK ASSEMBLY

(71) Applicant: Ian Bartos, Victoria (AU)

(72) Inventor: Ian Bartos, Victoria (AU)

(73) Assignee: Gainsborough Hardware Industries Limited, Blackburn (AU)

(21) Appl. No.: 13/509,259

(22) PCT Filed: Oct. 13, 2010
(86) PCT No.: PCT/AU10/01349

§ 371 Date: Nov. 16, 2012

(30) Foreign Application Priority Data
Nov. 10, 2009 (AU) 2009905497

(51) Int. Cl. E05C 1/10; E05B 21/06; E05C 1/08

(52) U.S. Cl. 70/357; 292/145; 292/137

(57) ABSTRACT

A lock assembly (20) adapted for handing. The lock assembly (20) includes a housing, a lock bolt (34), a first hub, (42) a locking bar (74) and a first hub locker (70). The lock bolt (34) is movable between a latching position and an unlatching position. The first hub (42) is adapted to move the lock bolt (34) in response to movement of a first handle. The locking bar (74) is movable between an advanced position and a withdrawn position. The first hub locker (70) is releasably engageable with the locking bar (74) at either of a first position or a second position relative to the locking bar (74). The first hub locker (70) retains its position relative to the housing (21) whilst being released from engagement with the locking bar (74) at one of the first position or the second position, thereby allowing movement of the locking bar (74) relative to the housing (21) and to the first hub locker (70) for engagement of the first hub locker (70) at the other of the first position or the second position.

### FIELD OF THE INVENTION

The present invention relates to a lock assembly that is adapted for handing.

The invention has been primarily developed in relation to a mortice lock assembly for a door and will be described hereinafter with reference to that application. However, the invention can also be used in other types of lock assemblies, including surface mounted locks.

### BACKGROUND OF THE INVENTION

Mortice locks utilise two hubs, each associated with a lever or other handle on each side of a door. They can be configured to provide any one only of four different pairs of functions when locked or unlocked, as follows:

(Pair 1) Unlocked function—door can be opened for entry or egress from either side without key. Locked function—door can be opened for entry without key but key needed for egress (i.e. by unlocking or by latch retracting/key over-riding without unlocking);

(Pair 2) Unlocked function—door can be opened for entry or egress from either side without key. Locked function—door can be opened for egress without key but key needed for entry;

(Pair 3) Unlocked function—door can be opened for entry or egress from either side without key. Locked function—key needed for entry and egress; or

(Pair 4) Unlocked function—door can be opened for entry or egress from either side without key. Locked function—door can be opened for entry or egress from either side without key (effectively creating a latch).

Configuring a lock in the desired one of the four above function pairs is known as handing the locking mechanism and allows the lock installer to ensure that the pair of functions best matches the requirement of a particular door. The ability to hand a lock: saves a lock manufacturer from having to make, stock and sell four different locks, one for each of the above four pairs of functions; saves a customer from having to know which parts to order for which door; and avoids an incorrectly handed lock from being delivered. These last two requirements can be particularly important when purchasing a large number of locks for installation in, for example, a multi-storey building with many doors.

Handing is done by adjusting or manipulating one or more of the lock's components. Lock assemblies that can be handed during installation are known, see for example Australian Patent Nos. 647236, 686403 and 2005203686 and PCT Patent Application No. PCT/AU2005/001572 (WO 2006/039751).

### OBJECT OF THE INVENTION

It is an object of the invention to provide an alternative lock assembly that is adapted for handing.

### SUMMARY OF THE INVENTION

Accordingly, in a first aspect, the present invention provides a lock assembly adapted for handing, the lock assembly including:

a housing;

a lock bolt movable between a latching position and an unlatching position; is a first hub adapted to move the lock bolt in response to movement of a first handle;

a locking bar movable between an advanced position and a withdrawn position; and

a first hub locker that is releasably engageable with the locking bar at either of a first position or a second position relative to the locking bar, the first hub locker retaining its position relative to the housing whilst being released from engagement with the locking bar at one of the first position or the second position, thereby allowing movement of the locking bar relative to the housing and to the first hub locker for engagement of the first hub locker at the other of the first position or the second position.

In a second aspect, the present invention provides a lock assembly adapted for handing, the lock assembly including:

a housing;

a lock bolt movable between a latching position and an unlatching position;

a first hub adapted to move the lock bolt in response to movement of a first handle;

a locking bar movable between an advanced position and a withdrawn position; and

a first hub locker that is releasably engageable with the locking bar at either of a first position or a second position relative to the locking bar, the first hub locker retaining its position relative to the housing whilst being released from engagement with the locking bar at one of the first position or the second position, thereby allowing movement of the locking bar relative to the housing and to the first hub locker for re-engagement of the first hub locker at the other of the first position or the second position,

wherein, when the locking bar is in the advanced position, engaging the first hub locker at the first position or the second position will cause the first hub locker to respectively prevent or allow movement of the first hub thereby respectively preventing or allowing movement of the lock bolt, in response to rotation of the first hub, from the latching position to the unlatching position, and

when the locking bar is in the withdrawn position, engaging the first hub locker at the first position or the second position will cause the first hub locker to allow movement of the first hub thereby allowing movement of the lock bolt, in response to rotation of the first hub, from the latching position to the unlatching position.

In a third aspect, the present invention provides a lock assembly adapted for is handing, the lock assembly including:

a housing;

a lock bolt movable between a latching position and an unlatching position;

a first hub adapted to move the lock bolt in response to movement of a first handle;

a locking bar movable between an advanced position and a withdrawn position; and

a first hub locker that is releasably engageable with the locking bar at either of a first position or a second position relative to the locking bar, the first hub locker retaining its position relative to the housing whilst being released from engagement with the locking bar at one of the first position or the second position, thereby allowing movement of the locking bar relative to the housing and to the first hub locker for re-engagement of the first hub locker at the other of the first position or the second position,

wherein, when the first hub locker is in the first position and the locking bar is in the advanced position, the first hub locker prevents movement of the first hub thereby preventing movement of the lock bolt, in response to rotation of the first hub, from the latching position to the unlatching position,

when the first hub locker is in first position and the locking bar is in the withdrawn position, the first hub locker does not prevent movement of the first hub thereby not preventing movement of the lock bolt, in response to rotation of the first hub, from the latching position to the unlatching position, and

when the first hub locker is in the second position and the locking bar is in the advanced or withdrawn position, the first hub locker does not prevent movement of the first hub thereby not preventing movement of the lock bolt, in response to rotation of the first hub, from the latching position to the unlatching position.

The lock assembly preferably includes a first releasable engagement means adapted for engaging the first hub locker at one of the first position and the second position.

In one form, the first releasable engagement means is associated with the locking bar. The first engagement means is preferably mounted on or to the locking bar.

In another form, the first releasable engagement means is associated with the first hub locker. The first engagement means is preferably mounted on or to the first hub locker.

The first hub locker preferably includes a first end that is releasably engageable with the locking bar. The first hub locker preferably includes a second end that is pivotally mounted to the housing.

The lock assembly preferably includes a tool adapted to drive, most preferably push, the first engagement means out of engagement whilst simultaneously preventing movement of the first hub locker relative to the housing.

In one form, the first end of the first hub locker preferably includes pair of spaced apart regions, most preferably a first recess and a second recess, adapted to engage with a single said first engagement means on the locking bar in the first position or the second position respectively. The first engagement means is preferably a spring biased detent mounted on the locking bar.

In another form, the first end of the first hub locker preferably includes a single region, most preferably a first recess, adapted to engage with one of a pair of spaced apart said first engagement means on the locking bar in the first position or the second position respectively. The first engagement means is preferably a pair of spring biased detents adapted for common movement.

In yet another form, the first end of the first hub locker preferably includes a first engagement means, preferably a spring biased detent with a pair of recesses, adapted to engage with a single region of the locking bar in the first position or the second position respectively. The locking bar single region is preferably a protrusion or prong on the locking bar.

In yet further form, the first end of the first hub locker preferably includes a first engagement means, preferably a spring biased detent, adapted to engage with one of a pair of regions of the locking bar in the first position or the second position respectively.

The locking bar regions are preferably a pair of recesses, most preferably between three protrusions or prongs on the locking bar.

The lock assembly preferably also includes:

a second hub adapted to move the lock bolt in response to movement of a second handle;

a second hub locker that is releasably engageable with the locking bar at either of a first position or a second position relative to the locking bar, the second hub locker retaining its position relative to the housing whilst being released from engagement with the locking bar at one of the first position or the second position, thereby allowing movement of the locking bar relative to the housing and to the second hub locker for re-engagement of the second hub locker at the other of the first position or the second position.

The lock assembly preferably includes a second releasable engagement means adapted for engaging the second hub locker at one of the first position and the second position.

Preferably, when the locking bar is in the advanced position, engaging the second hub locker at the first position or the second position will cause the second hub locker to respectively prevent or allow movement of the second hub thereby respectively preventing or allowing movement of the lock bolt, in response to rotation of the second hub, from the latching position to the unlatching position, and

when the locking bar is in the withdrawn position, engaging the second hub locker at the first position or the second position will cause the second hub locker to allow movement of the second hub thereby allowing movement of the lock bolt, in response to rotation of the second hub, from the latching position to the unlatching position.

Preferably, when the second hub locker is in the first position and the locking bar is in the advanced position, the second hub locker prevents movement of the second hub thereby preventing movement of the lock bolt, in response to rotation of the second hub, from the latching position to the unlatching position;

when the second hub locker is in first position and the locking bar is in the withdrawn position, the second hub locker does not prevent movement of the second hub thereby not preventing movement of the lock bolt, in response to rotation of the second hub, from the latching position to the unlatching position, and

when the second hub locker is in the second position and the locking bar is in the advanced or withdrawn position, the second hub locker does not prevent movement of the second hub thereby not preventing movement of the lock bolt, in response to rotation of the second hub, from the latching position to the unlatching position.

The first releasable engagement means is preferably movable in direction parallel to a longitudinal axis of the first hub. The second releasable engagement means is preferably movable in direction parallel to a longitudinal axis of the second hub. The longitudinal axes of the first and second hubs are preferably coincident.

The housing preferably has a pair of parallel sides and the first releasable engagement means is preferably movable in a direction normal to the plane of the housing sides. The second releasable engagement means is preferably also movable in a direction normal to the plane of the housing sides.

The locking assembly preferably includes a key cylinder which is fixable relative to the housing with a pin. The key cylinder is preferably adapted to move the locking bar between the advanced position and the withdrawn position. The pin preferably has an end adapted for passage through the first hub locker for depression of the first releasable engagement means. The pin end is preferably also adapted for passage through the second hub locker for depression of the second releasable engagement means.

The housing preferably includes an opening receiving therein a key cylinder and a locking bar driver, adapted for moving the locking bar between the advanced and withdrawn positions, that is manually accessible through the opening. The locking bar driver is preferably a lever pivotally mounted to the housing.

The first hub preferably includes a protuberance and the first hub locker includes a third recess adapted to engage with said protuberance to prevent movement of the first hub when so engaged. The second hub preferably includes a protuberance and the second hub locker includes a third recess adapted to engage with said protuberance to prevent movement of the second hub when so engaged.

In a fourth aspect, the present invention provides a lock assembly adapted for handing, the lock assembly including:

a lock bolt;

a housing with a first side adjacent the lock bolt, a second side opposed to the first side; a top; a bottom opposed to the top; a front face, and a rear face opposed to the front face;

a locking bar movable between an advanced position and a withdrawn position;

a first hub locker with a first recess and a second recess; and

a first detent associated with the locking bar and biased towards engagement with the first hub locker at one of the first recess and the second recess, the first detent being releasable from engagement with one of the first recess and the second recess, in response to insertion of a tool in a direction normal to the front or rear face, to prevent movement of the first hub locker relative to the housing and allow movement of the locking bar relative to the housing and to the first hub locker for engagement of the first detent with the other of the first recess and the second recess in order to set the handing of the lock assembly.

### BRIEF DESCRIPTION OF THE DRAWINGS

Preferred embodiments will now be described, by way of examples only, with reference to the accompanying drawings, in which:

FIG. 1 is a perspective view of a first embodiment of a locking assembly;

FIG. 2 is a perspective view of the lock assembly shown in FIG. 1 with face plate removed and key cylinder retaining pin partially removed;

FIG. 3 is a perspective view of the lock assembly shown in FIG. 1 with key cylinder retaining pin positioned ready for handing;

FIG. 4 is a perspective view of the locking assembly shown in FIG. 1, with front cover removed, hub locker inactive and locking bar withdrawn;

FIG. 5 is a side view of the hub locker and locking bar in the configuration shown in FIG. 4;

FIG. 6 is a perspective view of the lock assembly shown in FIG. 4 after rotation of hub and retraction of bolts;

FIG. 7 is a perspective view of the lock assembly shown in FIG. 4 with hub locker inactive and locking bar advanced;

FIG. 8 is an enlarged partial detail view of the lock assembly shown in FIG. 7;

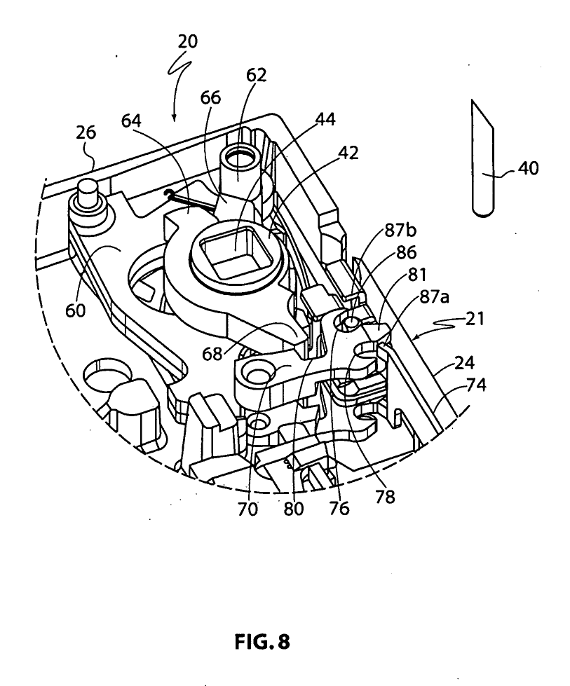

FIG. 9 is a side view of the hub locker and locking bar in the configuration shown in FIGS. 7 and 8;

FIG. 10 is a perspective view of the lock assembly shown in FIG. 7 after rotation of hub and retraction of bolts;

FIG. 11 is a perspective view of the lock assembly shown in FIG. 4 with hub locker active and locking bar advanced;

FIG. 12 is a side view of the hub locker and locking bar in the configuration shown in FIG. 11;

FIG. 13 is an enlarged partial detail view of the lock assembly with hub locker active and locking bar withdrawn;

FIG. 14 is a side view of the hub locker and locking bar in the configuration to shown in FIG. 13;

FIG. 15 is a perspective view of a locking bar;

FIG. 16 is a perspective view of an alternative hub lockers, locking bar;

FIG. 17 is a perspective view of a further alternative hub lockers and locking bar; and

FIG. 18 is a perspective view of a yet further alternative hub lockers and locking bar.

### DETAILED DESCRIPTION OF THE PREFERRED EMBODIMENTS

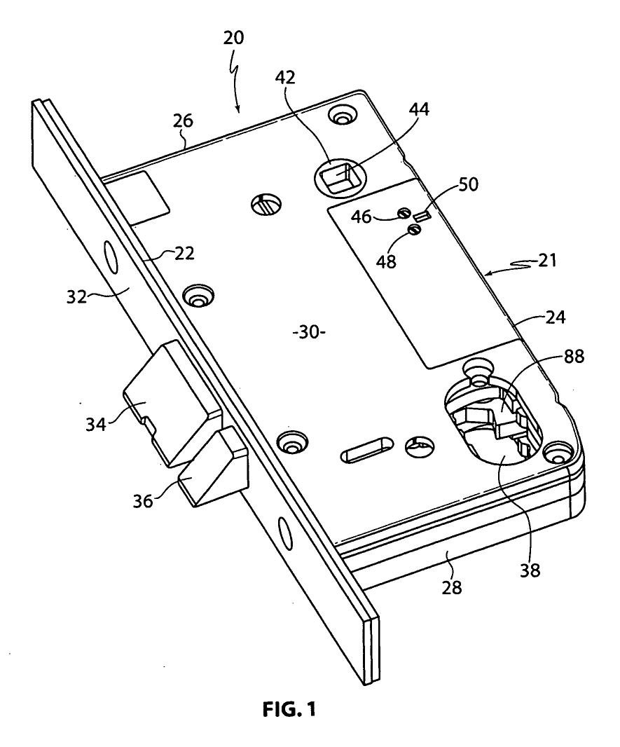

FIG. 1 shows a first embodiment of a lock assembly 20 that is adapted for handing. The lock assembly 20 includes a housing 21 with a first side 22, a second side 24, a top face 26, a bottom face 28, a front face 30 and a rear face (not shown). The lock assembly 20 is installed in a door with the first side 22 adjacent to the non-hinged edge of the door.

A face plate 32 is attached to the first side 22. A latch bolt 34 and an auxiliary bolt 36 pass through the face plate 32 for engagement with a strike plate (not shown) in a door jamb, as will be well understood by persons skilled in the art.

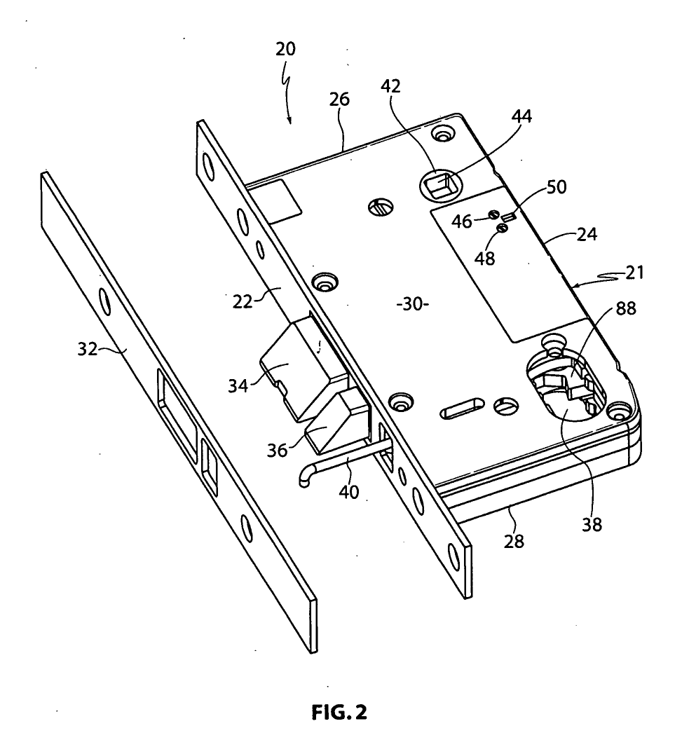

The lock assembly 20 also includes an opening 38 that receives a key cylinder (not shown). With reference to FIG. 2, the key cylinder is retained within the opening by engagement with a key cylinder retaining pin 40, as will also be well understood by persons skilled in the art. After the key cylinder has been inserted into the opening 38, and the key cylinder retaining pin 40 inserted into the key cylinder, the key cylinder retaining pin 40 is prevented from releasing its engagement with the key cylinder by engagement of the face plate 32 with the lock assembly side 22.

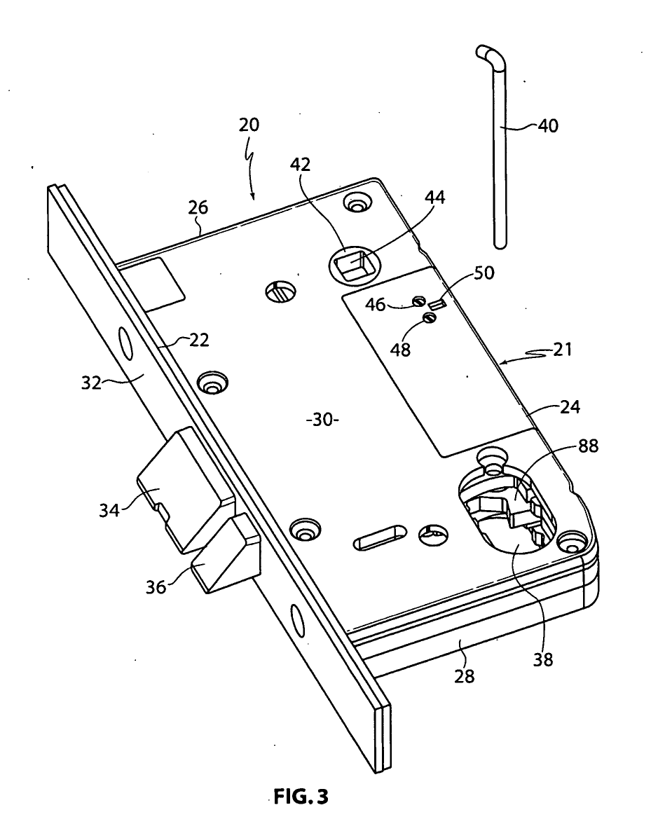

FIG. 3 shows the key cylinder retaining pin 40 removed from the lock assembly 20 and in a position ready for handing of the lock assembly 20, which shall be described in more detail below.

The lock assembly 20 also includes a first hub 42 with a square cross-section opening 44 therein, which is adapted to engage with a square cross-section drive shaft (not shown) of a first external knob, lever or other handle (not shown). The front surface 30 of the lock assembly also includes a first opening 46, a second opening 48 and a third opening 50, the functions of which shall also be described in more detail below in relation to the handing process.

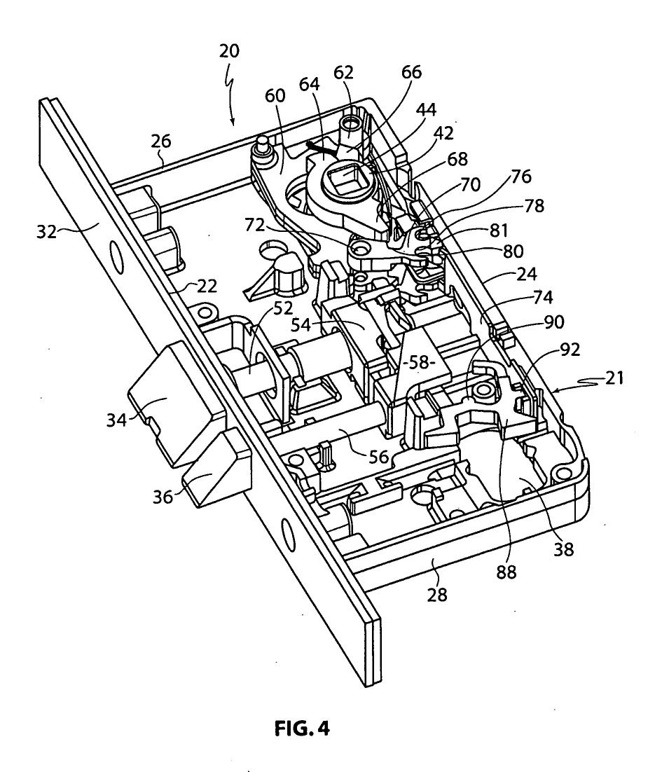

FIG. 4 shows the lock assembly 20 with the front 30 of the housing removed. The latch bolt 34 is connected to a bolt shaft 52 which is in turn connected to a bolt carriage 54. The auxiliary bolt 36 is connected to an auxiliary bolt shaft 56 which is in turn connected to an auxiliary bolt carriage 58. A carriage retraction arm 60 is pivotally mounted to the housing at shaft 62. The first hub 42 includes a first protuberance 64 is which is positioned adjacent a protuberance 66 on the arm 60. Rotation of the hub 42 drives the protuberance 64 against the protuberance 66 causing the arm 60 to pivot about shaft 62.

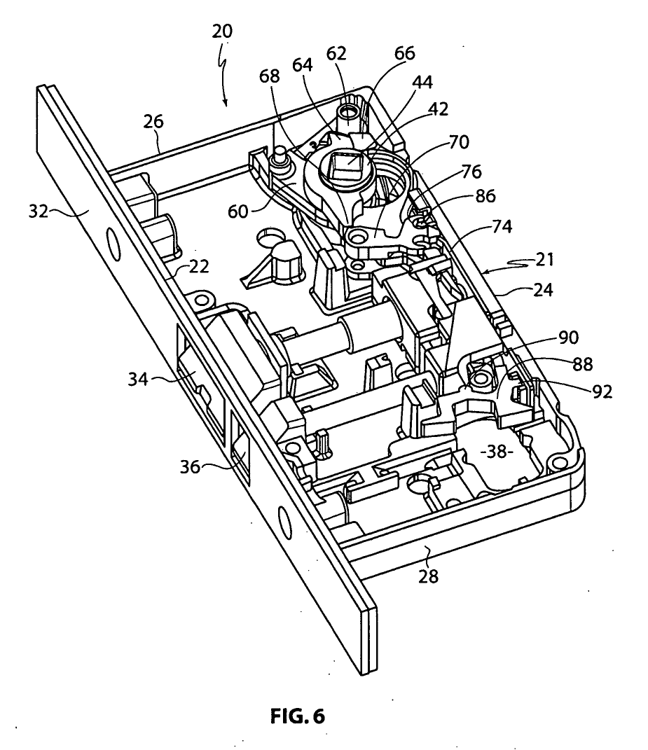

When the first hub 42 is rotated, it causes the arm 60 to move away from the first side 22 and towards the second side 24, which causes the carriages 54 and 58 to move in the same direction. The movement of the carriages 54 and 58 away from the first side 22 and towards the second side 24 causes similar respective movements in the latch bolt 34 and the auxiliary bolt 36, thereby retracting them into the housing 21. FIG. 6 shows the lock assembly 20 after pivoting of the hub 42 and resultant retraction of the latch bolt 34 and auxiliary bolt 36. When the latch bolt 34 and the auxiliary bolt 36 have been retracted, the door may be opened.

The first hub 42 also includes a second protuberance 68. The lock assembly 20 also includes a first hub locker 70 which is pivotally mounted to the housing at shaft 72. The lock assembly also includes a locking bar 74. The first hub locker 70 includes a first recess 76, a second recess 78, a third recess 80 and a tang 81, the functions of which shall also be described below.

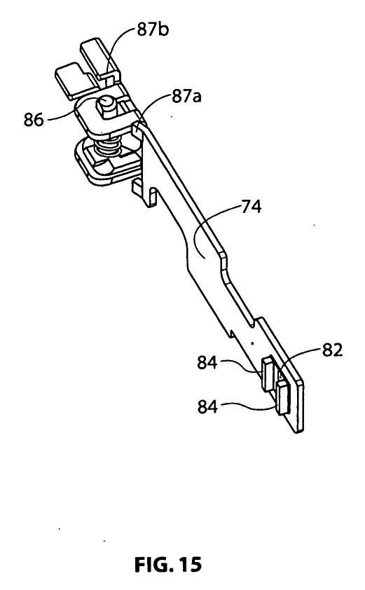

FIG. 15 shows the locking bar 74 in isolation. The locking bar 74 includes an opening 82 at one end between two tabs 84. The other end of the locking bar 74 includes a spring loaded detent 86 between two additional tabs 87a and 87b. The purpose of the tabs 84, 87a and 87b will be described below. The locking bar 74 is mounted adjacent the second side 24 of the housing for sliding movement between an “advanced” position moved towards the top of the housing 26 and a “withdrawn” position moved towards the bottom of the housing 28.

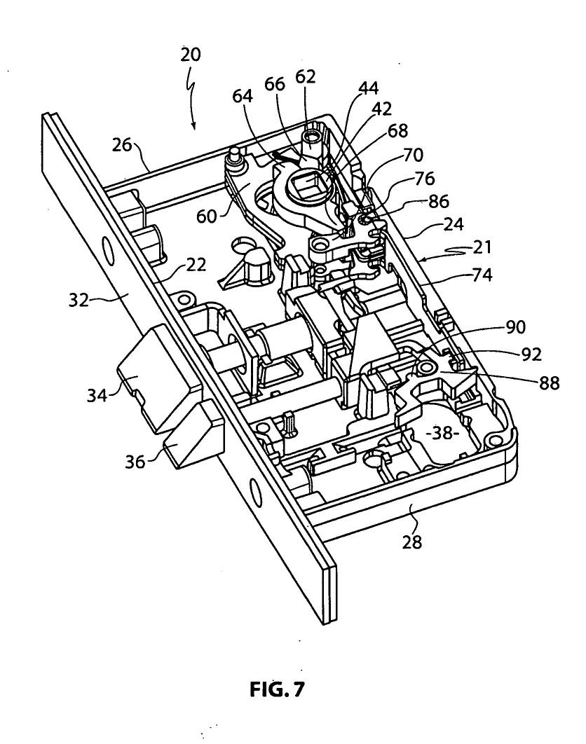

Returning to FIG. 4, the lock assembly 20 includes a locking bar driver 88 which is adapted for pivotal movement about a shaft 90. The driver includes a protuberance 92 which is received within the opening 82 in the locking bar 74. The driver 88 is pivoted to move the locking bar between the advanced and withdrawn positions. For example, FIG. 4 shows the locking bar 74 driven to the withdrawn position and FIG. 7 shows the locking bar 74 driven to the advanced position. The position of the locking bar 74 can be adjusted in two ways. Firstly, prior to installation of the lock assembly 20 the driver 88 can be pivoted to a desired position by use of a finger or tool inserted into the opening 38. After installation, a cam associated with the key cylinder can be used to alter the position of the driver 88, as will be described in more detail below. The provision of a cam on the exterior of a key cylinder will also be understood by persons skilled in the art.

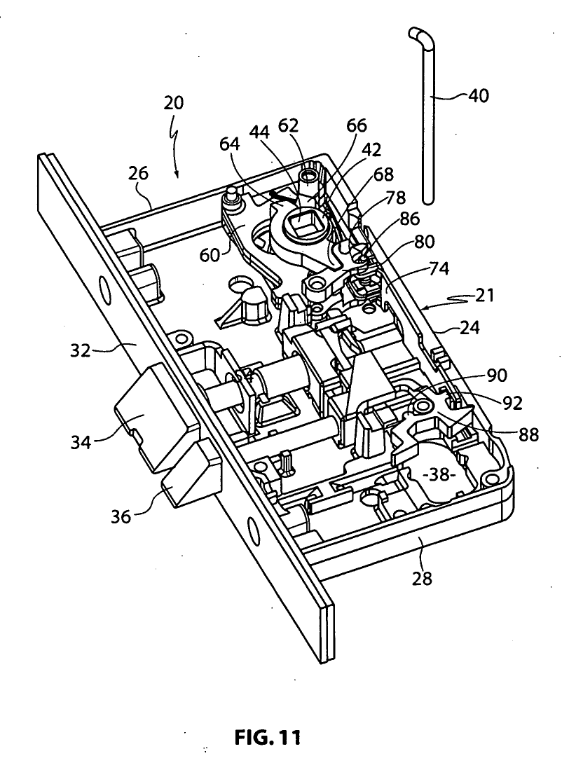

The detent 86 of the locking bar 74 can engage with either the first recess 76 (at what will be referred to hereafter as the first or “inactive” position) or the second recess 78 (at what will be referred to hereafter as the second or “active” position) of the hub locker 70. For example, FIG. 4 shows the detent 86 engaged with the first recess 76 and FIG. 11 shows the detent 86 engaged with the second recess 78. The hub locker 70 and the locking bar 74 can be positioned relative to the hub 42 in four different ways, in order to prevent or allow the hub 42 to be rotated, and thus the door opened, as summarised below.

Locking bar 74

| | | Advanced | Withdrawn |
|---|---|---|---|
| Hub locker 70 | Active | Door unable to be | Door able to be |
| | | opened | opened |
| | Inactive | Door able to be | Door able to be |
| | | opened | opened |

The description of the lock assembly 20 thus far has referred to the first hub 42, a first handle and the first hub locker 70, which are all adjacent to the front face 30 of the lock housing 21. It will also be appreciated that these components are mirrored and a second hub, a second handle and a second hub locker are provided adjacent the rear face of the housing 21 and operate in an identical manner as previously described in relation to the first hub, the first handle and the first hub locker. Similarly, the locking bar 74 has the first detent 86 adapted to engage with the first hub locker 70 which is biased towards the front face 30 of the lock housing 21 and also a second detent, which is adapted to engage with the second hub locker and is biased towards the rear face of the housing 21. The rear face of the housing 21 also includes a set of first, second and third openings (similar to openings 46, 48 and 50 in the front face 30).

The handing of the lock assembly 20 shall now be described.

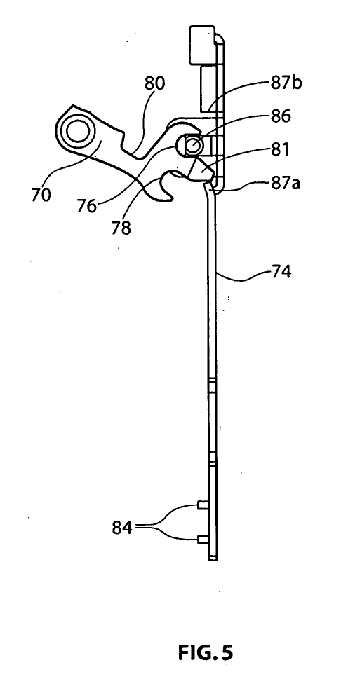

FIGS. 4 and 5 show the detent 86 of the locking bar 70 engaged with the first recess 76 of the hub locker 70 or, in other words, the hub locker 70 is set inactive. FIGS. 4 and 5 also show the locking bar 74 in the withdrawn position.

As shown in FIG. 6, in this configuration the second protuberance 68 on the first hub 42 is not in engagement with the third recess 80 of the first hub locker 70 and the hub 42 is thus able to be rotated by movement of an associated handle in order to withdraw the bolts 34 and 36 and open the door.

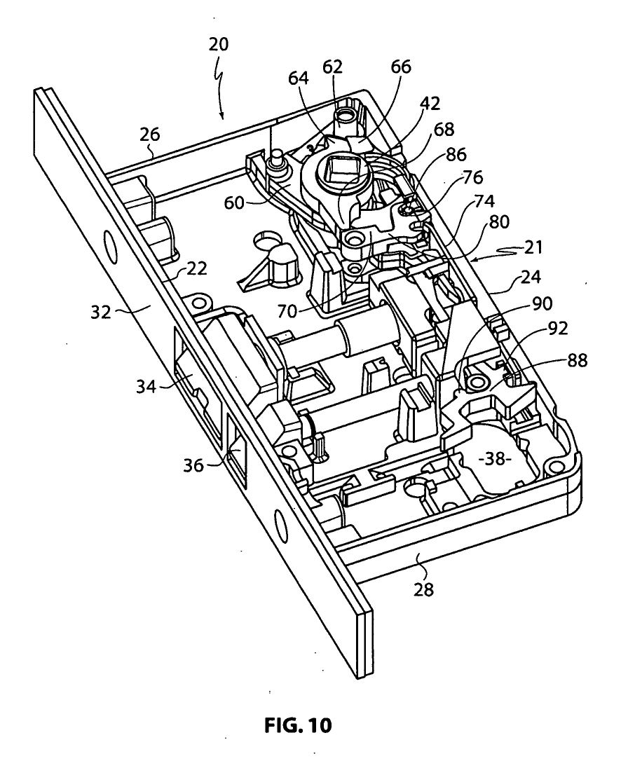

FIG. 7 shows the lock assembly with the hub locker 70 still set inactive but with the locking bar 74 moved to the advanced position. In this configuration, the protuberance 68 is free of engagement with the third recess 80 allowing the door to be opened in response to rotation of a handle associated with the first hub 42, as shown in FIG. 10.

FIG. 11 shows the first hub locker 70 set active with the detent 86 of the locking bar 74 engaged with the second recess 78. FIG. 11 also shows the locking bar 74 in the advanced position. In this configuration, the protuberance 68 on the first hub 42 is received within, and engages, the first recess 80 on the hub locker 70. This engagement prevents the first hub 42 from being rotated, thereby preventing the bolts 34 and 36 from being retracted by rotation of the first hub 42 to open the door. In other words, relative to the first handle, the door is locked in this configuration.

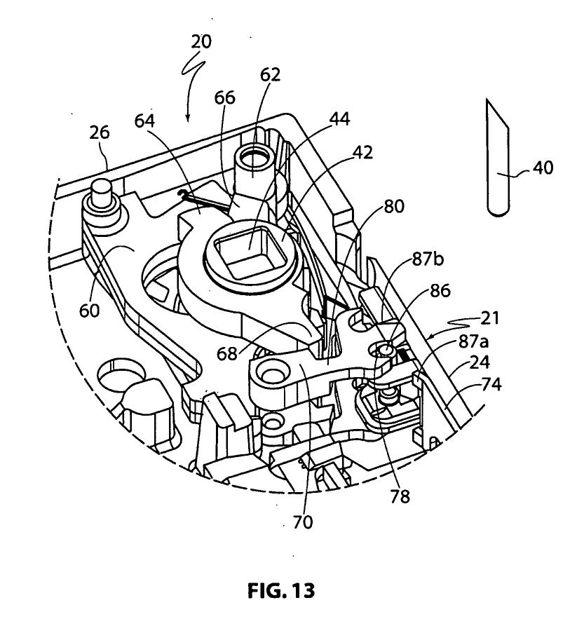

FIG. 13 shows the first hub locker 70 set active with the detent 86 engaged with the second recess 78 and the locking bar 74 in the withdrawn position. In this configuration, the protuberance 68 is free of engagement with the recess 80, thereby allowing the door to be opened by rotation of the first hub 42.

The above described arrangement allows the first and second hub lockers to be independently set either active or inactive and then the locking of the first and second hubs to be controlled by the positioning of the locking bar 74 in the advanced or withdrawn position. If both of the first and second hub lockers are set inactive, then the door can be opened from either side regardless of the position of the locking bar. If both of the first and second hub lockers are set active, then the door can be opened from either side when the locking bar 74 is in the withdrawn position and is unable to be opened from either side when the locking bar 74 is in the advanced position. If the first hub locker is set active and the second hub locker is set inactive, then the door can be opened from either side when the locking bar 74 is in the withdrawn position and can only be opened from the second side when the locking bar 74 is in the advanced position. If the first hub locker is set inactive and the second hub locker is set active, then the door can be opened from either side when the locking bar 74 is in the withdrawn position and can only be opened from the first side when the locking bar 74 is in the advanced position.

As previously explained, once the lock assembly 20 has been installed, a correct key inserted into the key cylinder allows a user to drive the locking bar 74 between the advanced and withdrawn positions, thereby locking none, one or both sides of the door dependent on the positioning of the first and second hub lockers.

Before installation of the lock assembly 20, a user is able to determine whether either of the first or second hub lockers is set active or inactive by examining apertures 46, 48 and 50.

To determine the handing of a side of the lock assembly 22, the tang 81 must be visible through the aperture 50 on that side of the lock assembly 22. If necessary, the tang 81 can be positioned behind the aperture 50 by finger action on the driver 88 to move the locking bar 74, with the hub locker 70, and carry the tang 81 into a visible position.

When the tang 50 is visible, handing is assessed by checking the position of the detent 86, which will be visible through either the aperture 46 or the aperture 48. If the detent 86 is visible through the aperture 46, then the hub locker 70 is inactive. If the detent 86 is visible through the aperture 48, then the hub locker 70 is active.

To change the handing of a side of the lock assembly 20, the tang 81 must be visible through the aperture 50 on that side of the lock. If necessary, tang 81 can be positioned behind the aperture 50 by finger action on driver 88 to move the locking bar 74, with the hub locker 70, and carry the tang 81 into a visible position.

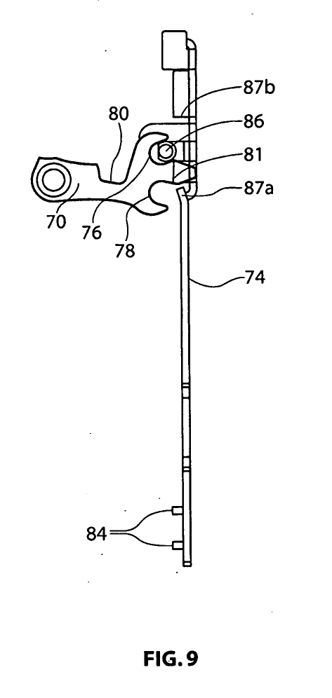

To change the hub locker 70 from active to inactive, when the tang 81 is visible, the key cylinder retaining pin 40 is inserted into the second aperture 48, in a direction normal to and towards the plane of the first face 30, to depress the detent 86 out of engagement with the second recess 78. The key cylinder retaining pin 40 also passes through the second recess 78, thereby preventing movement of the first hub locker 70 relative to the housing. Whilst the detent 86 is held in this depressed position by the key cylinder retaining pin 40, the driver 88 is pivoted in order to slide the locking bar 74, relative to the housing 21, towards the advanced position. This causes the detent 86 to move into a position adjacent the first recess 76. The detent 86 then automatically enters the recess 76 as it is spring biased towards same. The locking bar 74 and the detent 86 are prevented from being inadvertently moved past the first recess 76 by the tang 81 abutting the tab 87a (see FIG. 9). The key cylinder retaining pin 40 is then removed from the aperture 48 leaving the hub locker 70 in the inactive position. During motion of the locking bar 74 and the detent 86, the key cylinder retaining pin 40 serves to retain the hub locker 70 motionless, relative to the housing, so the detent 86 can travel from the recess 78 to the recess 76.

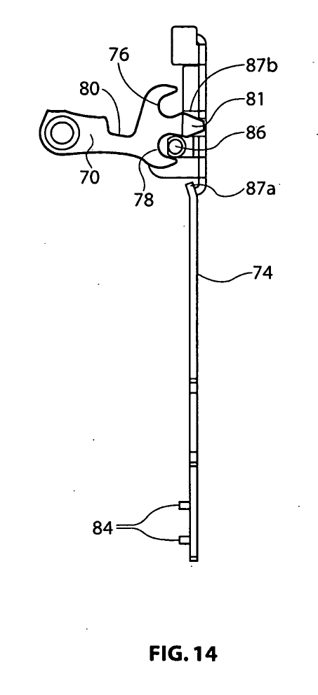

To change the hub locker 70 from inactive to active, when the tang 81 is visible, the key cylinder retaining pin 40 is inserted into the first aperture 46, in a direction normal to and towards the plane of the first face 30, to depress the detent 86 out of engagement with the first recess 76. The key cylinder retaining pin 40 also passes through the first recess 76 on the first hub locker 70, thereby preventing movement of the hub locker 70 relative to the housing 21. Whilst the detent 86 is held in this depressed position by the key cylinder retaining pin 40, the driver 88 is pivoted in order to slide the locking bar 74, relative to the housing, towards the withdrawn position. This causes the detent 86 to move into a position adjacent the second recess 78. The locking bar 74 and the detent 86 are prevented from being inadvertently moved past the second recess 78 by the tang 81 abutting the tab 87b (see FIG. 14). The detent 86 then automatically enters the recess 78 as it is spring biased towards same. The key cylinder retaining pin 40 is then removed from the aperture 46 leaving the hub locker 70 in the active position. During motion of locking bar 74 and the detent 86, the key cylinder retaining pin 40 serves to retain the hub locker 70 motionless, relative to the housing, so the detent 86 can travel from the recess 76 to the recess 78.

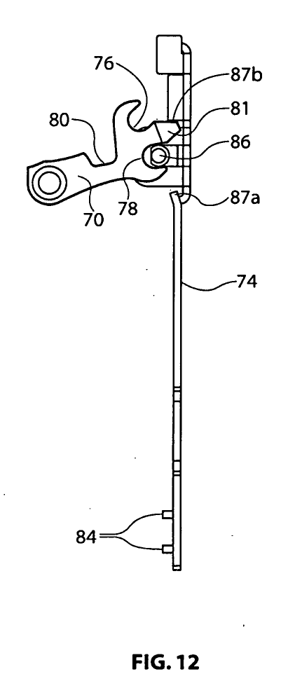

As previously described, the operation of changing handing of each side of the lock assembly 20 is foolproof, as the tabs 87a and 87b on the locking bar 74 abut the tang 81 of the hub locker 70 thereby ensuring that the detent 86 must be left in either one of the recesses 76 or 78 and not left disconnected from the hub locker 70. If this was not so, changing the handing may fail if the detent 86 was depressed when the tang 81 was not visible in the aperture 50 (see FIGS. 5 and 12).

Accordingly, the lock assembly 20 is advantageously able to be quickly and easily handed into any one of the four possible combinations without requiring any disassembly, and conveniently using a part of the lock assembly itself (the key cylinder retaining pin). This advantageously avoids any specialised tools being required and removes the risk of component loss or damage.

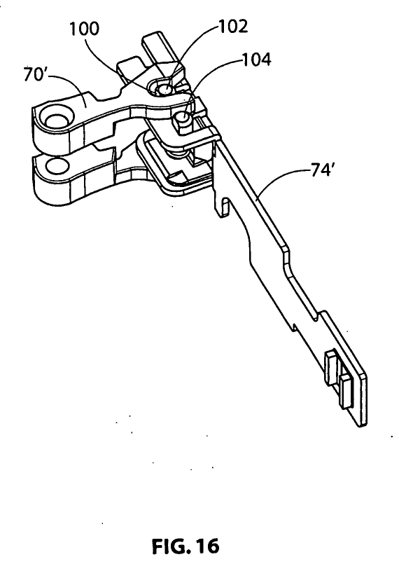

FIG. 16 shows an alternative form of a first hub locker 70′ and locking bar 74′, which can be used with the previously described lock assembly 20. The first hub locker 70′ includes a single recess 100 and the hub locker 74 includes a pair of spring biased detents 102 and 104, which move together. When the detent 102 is engaged within the recess 100, the first hub locker 70′ is in the previously described “active” position and when the detent 104 is within the recess 100, the first hub locker 70′ is in the previously described “inactive” position. As with the previously described embodiments, the key cylinder retaining pin 40 is used to depress the detents 102, 104 out of engagement with the recess 100 and simultaneously prevent the first hub locker 70′ from moving relative to the housing 21, thereafter the locking bar 70′ can be moved relative to the housing 21 in order to alter the handing of the lock assembly 20 in a similar manner to that previously described.

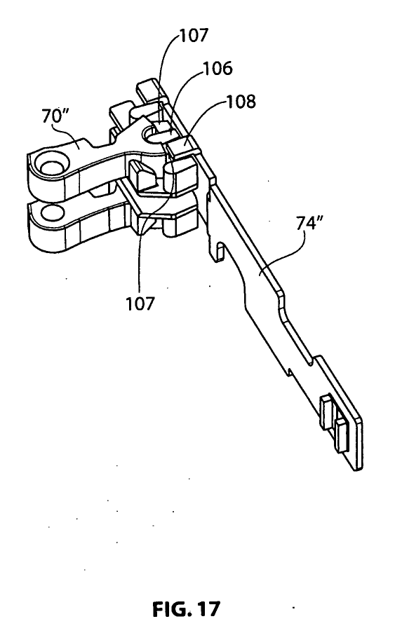

FIG. 17 shows a further variation of first hub locker 70″ and locking bar 74″. The hub locker 70″ carries a detent 106 that has a pair of recesses 107, corresponding to the active and inactive positions previously described. The locking bar 74″ carries a prong 108 which can be engaged with either of the recesses 107 in order to position the first hub locker 70″ in the active or inactive position. Once again, the key cylinder retaining pin 40 is used to depress the detent 106 to move the recess 107 out of engagement with the prong 108 whilst simultaneously preventing movement of the first hub locker 70″ relative to the housing 21, thereby allowing the locking bar 74″ to be moved relative to the housing 21 for rehanding of the lock assembly 20 in a similar manner to that previously described.

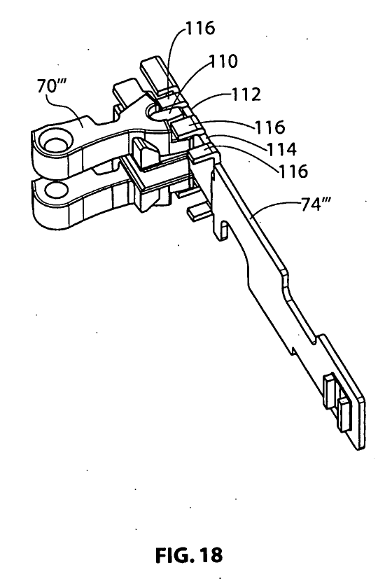

FIG. 18 shows a yet further alternate form of first hub locker 70″′ and locking bar 70″′. The first hub locker 70 has a detent 110. The locking bar 74 includes a first recess 112 and a second recess 114, respectively corresponding to the active and inactive positions previously described, between three prongs 116. As with earlier embodiments, the key cylinder retaining pin 40 is used to depress the detent 110 out of engagement with one of the recesses 112 or 114 and simultaneously prevent the first hub locker 70″′ from moving relative to the housing 21. The locking bar 74″′ can then be moved relative to the housing 21 to alter the handing of the lock assembly 20 in a similar manner to that previously described.

Although the invention has been described with reference to a specific example, a person skilled in the art will appreciate that the invention may be embodied in many other forms.

1. A lock assembly adapted for handing, the lock assembly including:
a housing;
a lock bolt movable between a latching position and an unlatching position; a first hub adapted to move the lock bolt in response to movement of a first handle;
a locking bar movable between an advanced position and a withdrawn position; and
a first hub locker that is releasably engageable with the locking bar at either of a first position or a second position relative to the locking bar, the first hub locker retaining its position relative to the housing whilst being released from engagement with the locking bar at one of the first position or the second position, thereby allowing movement of the locking bar relative to the housing and to the first hub locker for engagement of the first hub locker at the other of the first position or the second position.

2. A lock assembly adapted for handing, the lock assembly including:
a housing;
a lock bolt movable between a latching position and an unlatching position; +
a first hub adapted to move the lock bolt in response to movement of a first handle;
a locking bar movable between an advanced position and a withdrawn position; and
a first hub locker that is releasably engageable with the locking bar at either of a first position or a second position relative to the locking bar, the first hub locker retaining its position relative to the housing whilst being released from engagement with the locking bar at one of the first position or the second position, thereby allowing movement of the locking bar relative to the housing and to the first hub locker for re-engagement of the first hub locker at the other of the first position or the second position,
wherein, when the locking bar is in the advanced position, engaging the first hub locker at the first position or the second position will cause the first hub locker to respectively prevent or allow movement of the first hub thereby respectively preventing or allowing movement of the lock bolt, in response to rotation of the first hub, from the latching position to the unlatching position, and
when the locking bar is in the withdrawn position, engaging the first hub locker at the first position or the second position will cause the first hub locker to allow movement of the first hub thereby allowing movement of the lock bolt, in response to rotation of the first hub, from the latching position to the unlatching position.

3. A lock assembly adapted for handing, the lock assembly including:
a housing;
a lock bolt movable between a latching position and an unlatching position; a first hub adapted to move the lock bolt in response to movement of a first handle;
a locking bar movable between an advanced position and a withdrawn position; and
a first hub locker that is releasably engageable with the locking bar at either of a first position or a second position relative to the locking bar, the first hub locker retaining its position relative to the housing whilst being released from engagement with the locking bar at one of the first position or the second position, thereby allowing movement of the locking bar relative to the housing and to the first hub locker for re-engagement of the first hub locker at the other of the first position or the second position,
wherein, when the first hub locker is in the first position and the locking bar is in the advanced position, the first hub locker prevents movement of the first hub thereby preventing movement of the lock bolt, in response to rotation of the first hub, from the latching position to the unlatching position,
when the first hub locker is in first position and the locking bar is in the withdrawn position, the first hub locker does not prevent movement of the first hub thereby not preventing movement of the lock bolt, in response to rotation of the first hub, from the latching position to the unlatching position, and
when the first hub locker is in the second position and the locking bar is in the advanced or withdrawn position, the first hub locker does not prevent movement of the first hub thereby not preventing movement of the lock bolt, in response to rotation of the first hub, from the latching position to the unlatching position.

4. The lock assembly as claimed in claim 1, wherein the lock assembly includes a first releasable engagement means adapted for engaging the first hub locker at one of the first position and the second position.

5. The lock assembly as claimed in claim 4, wherein the first releasable engagement means is associated with the locking bar.

6. The lock assembly as claimed in claim 5, wherein the first releasable engagement means is mounted on or to the locking bar.

7. The lock assembly as claimed in claim 4, wherein the first releasable engagement means is associated with the first hub locker.

8. The lock assembly as claimed in claim 7, wherein the first releasable engagement means is mounted on or to the first hub locker.

9. The lock assembly as claimed in claim 4 wherein the first hub locker includes a first end that is releasably engageable with the locking bar.

10. The lock assembly as claimed in claim 9, wherein the first hub locker includes a second end that is pivotally mounted to the housing.

11. The lock assembly as claimed in claim 4, wherein the lock assembly includes a tool adapted to drive the first releasable engagement means out of engagement whilst simultaneously preventing movement of the first hub locker relative to the housing.

12. The lock assembly as claimed in claim 4, wherein the lock assembly includes a tool adapted to push the first releasable engagement means out of engagement whilst simultaneously preventing movement of the first hub locker relative to the housing.

13. The lock assembly as claimed in claim 9, wherein the first end of the first hub locker includes pair of spaced apart regions adapted to engage with a single said first releasable engagement means on the locking bar in the first position or the second position respectively.

14. The lock assembly as claimed in claim 13, wherein the pair of spaced apart regions are a first recess and a second recess.

15. The lock assembly as claimed in claim 13, wherein the first releasable engagement means is a spring biased detent mounted on the locking bar.

16. The lock assembly as claimed in claim 9, wherein the first end of the first hub locker includes a single region adapted to engage with one of a pair of spaced apart said first releasable engagement means on the locking bar in the first position or the second position respectively.

17. The lock assembly as claimed in claim 16, wherein the single region is a first recess.

18. The lock assembly as claimed in claim 16, wherein the first releasable engagement means is a pair of spring biased detents adapted for common movement.

19. The lock assembly as claimed in claim 9, wherein the first end of the first hub locker includes a first releasable engagement means adapted to engage with a single region of the locking bar in the first position or the second position respectively.

20. The lock assembly as claimed in claim 19, wherein the first releasable engagement means is a spring biased detent with a pair of recesses.

21. The lock assembly as claimed in claim 19, wherein the locking bar single region is a protrusion or prong on the locking bar.

22. The lock assembly as claimed in claim 9, wherein the first end of the first hub locker includes a first releasable engagement means adapted to engage with one of a pair of regions of the locking bar in the first position or the second position respectively.

23. The lock assembly as claimed in claim 22, wherein the first releasable engagement means is a spring biased detent.

24. The lock assembly as claimed in claim 22, wherein the locking bar regions are a pair of recesses.

25. The lock assembly as claimed in claim 24, wherein the pair of recesses are between three protrusions or prongs on the locking bar.

26. The lock assembly as claimed in claim 1, wherein the lock assembly also includes:
a second hub adapted to move the lock bolt in response to movement of a second handle;
a second hub locker that is releasably engageable with the locking bar at either of a first position or a second position relative to the locking bar, the second hub locker retaining its position relative to the housing whilst being released from engagement with the locking bar at one of the first position or the second position, thereby allowing movement of the locking bar relative to the housing and to the second hub locker for re-engagement of the second hub locker at the other of the first position or the second position.

27. The lock assembly as claimed in claim 26, wherein the lock assembly includes a second releasable engagement means adapted for engaging the second hub locker at one of the first position and the second position.

28. The lock assembly as claimed in claim 27, wherein, when the locking bar is in the advanced position, engaging the second hub locker at the first position or the second position will cause the second hub locker to respectively prevent or allow movement of the second hub thereby respectively preventing or allowing movement of the lock bolt, in response to rotation of the second hub, from the latching position to the unlatching position, and when the locking bar is in the withdrawn position, engaging the second hub locker at the first position or the second position will cause the second hub locker to allow movement of the second hub thereby allowing movement of the lock bolt, in response to rotation of the second hub, from the latching position to the unlatching position.

29. The lock assembly as claimed in claim 27, wherein when the second hub locker is in the first position and the locking bar is in the advanced position, the second hub locker prevents movement of the second hub thereby preventing movement of the lock bolt, in response to rotation of the second hub, from the latching position to the unlatching position;
when the second hub locker is in first position and the locking bar is in the withdrawn position, the second hub locker does not prevent movement of the second hub thereby not preventing movement of the lock bolt, in response to rotation of the second hub, from the latching position to the unlatching position, and
when the second hub locker is in the second position and the locking bar is in the advanced or withdrawn position, the second hub locker does not prevent movement of the second hub thereby not preventing movement of the lock bolt, in response to rotation of the second hub, from the latching position to the unlatching position.

30. The lock assembly as claimed in claim 27, wherein the first releasable engagement means is movable in direction parallel to a longitudinal axis of the first hub.

31. The lock assembly as claimed in claim 30, wherein the second releasable engagement means is movable in direction parallel to a longitudinal axis of the second hub.

32. The lock assembly as claimed in claim 31, wherein the longitudinal axes of the first and second hubs are coincident.

33. The lock assembly as claimed in claim 27, wherein the housing has a pair of parallel sides and the first releasable engagement means is movable in a direction normal to the plane of the housing sides.

34. The lock assembly as claimed in claim 33, wherein the second releasable engagement means is also movable in a direction normal to the plane of the housing sides.

35. The lock assembly as claimed in claim 34, wherein the locking assembly includes a key cylinder which is fixable relative to the housing with a pin.

36. The lock assembly as claimed in claim 35, wherein the key cylinder is adapted to move the locking bar between the advanced position and the withdrawn position.

37. The lock assembly as claimed in claim 35, wherein the pin has an end adapted for passage through the first hub locker for depression of the first releasable engagement means.

38. The lock assembly as claimed in claim 35, wherein the pin end is also adapted for passage through the second hub locker for depression of the second releasable engagement means.

39. The lock assembly as claimed in claim 35 wherein the housing includes an opening receiving therein a key cylinder and a locking bar driver, adapted for moving the locking bar between the advanced and withdrawn positions, that is manually accessible through the opening.

40. The lock assembly as claimed in claim 39, wherein the locking bar driver is a lever pivotally mounted to the housing.

41. The lock assembly as claimed in claim 26, wherein the first hub includes a protuberance and the first hub locker includes a third recess adapted to engage with said protuberance to prevent movement of the first hub when so engaged.

42. The lock assembly as claimed in claim 41, wherein the second hub includes a protuberance and the second hub locker includes a third recess adapted to engage with said protuberance to prevent movement of the second hub when so engaged.

43. A lock assembly adapted for handing, the lock assembly including:
a lock bolt;
a housing with a first side adjacent the lock bolt, a second side opposed to the first side; a top; a bottom opposed to the top; a front face, and a rear face opposed to the front face;
a locking bar movable between an advanced position and a withdrawn position; a first hub locker with a first recess and a second recess; and
a first detent associated with the locking bar and biased towards engagement with the first hub locker at one of the first recess and the second recess, the first detent being releasable from engagement with one of the first recess and the second recess, in response to insertion of a tool in a direction normal to the front or rear face, to prevent movement of the first hub locker relative to the housing and allow movement of the locking bar relative to the housing and to the first hub locker for engagement of the first detent with the other of the first recess and the second recess in order to set the handing of the lock assembly.
